(19) United States
(12) Patent Application Publication
(10) Pub. No.: US 2015/0371481 A1
(43) Pub. Date: Dec. 24, 2015

(54) BANKNOTE RECOGNITION APPARATUS, PROCESSING METHOD THEREOF AND METHOD FOR RECORDING BANKNOTE PROCESSING STATE

(71) Applicant: SHANDONG NEW BEIYANG INFORMATION TECHNOLOGY CO., LTD., Weihai (CN)

(72) Inventors: Chunkai Xu, Weihai (CN); Shishui Zhang, Weihai (CN); Xiaoyan Gao, Weihai (CN)

(21) Appl. No.: 14/765,742

(22) PCT Filed: Jan. 20, 2014
(86) PCT No.: PCT/CN2014/070889

§ 371 Date: Aug. 4, 2015

(30) Foreign Application Priority Data
Feb. 4, 2013 (CN) 201310045393.3

(51) Int. Cl. G07D 11/00

(52) U.S. Cl. CPC G07D 11/0036; G07D 11/0069

(57) ABSTRACT

A banknote recognition apparatus, a processing method thereof and a method for recording a banknote processing state are disclosed. The banknote recognition apparatus includes a nonvolatile memory (14) and a control unit (11) configured to record a state of an event to the nonvolatile memory (14) during a banknote processing process, wherein the event is a key step in the banknote processing process. The apparatus and the method solve a problem that an abnormity often occurs when the banknote recognition apparatus stores banknote processing information to the nonvolatile memory (14) upon a power failure, thus the banknote processing information can be stored effectively when the power failure occurs on the banknote recognition apparatus.

The present application claims the priority of a Chinese invention application numbered 201310045393.3 and entitled “Banknote recognition apparatus, processing method thereof and method for recording banknote processing state” submitted to the State Intellectual Property Office of the People's Republic of China on Feb. 4, 2013, the entire disclosed content of which is incorporated herein for reference.

### TECHNICAL FIELD OF THE INVENTION

The present invention relates to the field of banknote processing, and particularly to a banknote recognition apparatus, a processing method thereof and a method for recording a banknote processing state.

### BACKGROUND OF THE INVENTION

Banknote recognition apparatus, which is widely used in financial institution such as bank, is configured to complete self-service banknote transaction. For example, a banknote recognition apparatus is installed in a self-service terminal device including a self-service deposit machine, and a self-service payment machine and so on. When processing a self-service deposit service or a self-service payment service, a user inputs banknotes into a banknote inlet of the self-service terminal device. The banknote recognition apparatus recognizes the banknotes inputted by the user, returns banknotes that cannot be recognized to the user, stores banknotes recognized as genuine banknotes in a cashbox of the banknote recognition apparatus, and uploads an amount of the banknotes stored in the cashbox to a host of the self-service terminal device. If the banknote recognition apparatus is powered off abnormally during a process of recognizing a banknote, unprocessed banknotes will be retained in the banknote recognition apparatus. In this case, the user usually needs to wait on the spot for a staff member to arrive in order to retrieve the inputted banknotes. However, an unnecessary dispute may be caused between the user and a financial institution because of inconsistent amounts of banknotes if the staff member performs an act of stealing when taking out the retained banknotes or the user fails to remember an amount of banknotes inputted into the banknote inlet.

To solve the foregoing problem, an automatic transaction processing device is disclosed by a Chinese patent whose application number is CN201010573107.7. The automatic transaction processing device includes a supply state detection mechanism, a power-off stop processing mechanism and a starting mechanism, and is powered by a primary side power supply. When the automatic transaction processing device operates, if the supply state detection mechanism detects that the primary side power supply stops supplying power, the power-off stop processing mechanism switches the power supply to a battery, and power is supplied by the battery. Transaction information during the power failure is stored in a nonvolatile memory. When the state detection mechanism detects that the primary side power supply starts to supply power again, the starting mechanism will continue to execute transaction processing being executed during the last power failure of the primary side power supply if the transaction information during the failure is stored in the nonvolatile memory.

Since the automatic transaction processing device needs to use the battery to supply power so as to store the transaction information being processed to the nonvolatile memory during the power failure, it is necessary to arrange an extra battery in the automatic transaction processing device, thus increasing the cost for manufacturing the automatic transaction processing device. Besides, transaction information is stored during power is supplied by the battery, an abnormality may occur when data is stored to the nonvolatile memory if the battery runs low, thereby resulting in a failure in storing the transaction information. Thus, the automatic transaction processing device may fail to correctly execute the transaction processing being executed during the last power failure when powered on again.

At present, there is no effective solution for solving a problem in a related technology that an abnormity often occurs when a banknote recognition apparatus stores banknote processing information to a nonvolatile memory upon a power failure.

### SUMMARY OF THE INVENTION

The major purpose of the present disclosure is to provide a banknote recognition apparatus, a processing method thereof and a method for recording a banknote processing state so as to solve the problem that an abnormity often occurs when a banknote recognition apparatus stores banknote processing information to a nonvolatile memory upon a power failure.

A banknote recognition apparatus is provided according to an aspect of the present disclosure in order to achieve the foregoing purpose. The banknote recognition apparatus includes: a nonvolatile memory; and a control unit configured to record a state of an event to the nonvolatile memory during a banknote processing process, wherein the event is a key step in the banknote processing process.

Further, the state of the event includes event start state and event end state; the event start state indicates start of the event and the event end state indicates end of the event.

Further, the nonvolatile memory is configured to record the state of the event using a state word; the control unit is configured to modify a value of the state word when the state of the event changes.

Further, the state of the event includes event start state and event end state; the event start state indicates start of the event and the event end state indicates end of the event, wherein the control unit is configured to set a bit corresponding to the event start state in the state word as a valid value when the event starts, and set a bit corresponding to the event end state in the state word as a valid value when the event ends; an initial value of the bit corresponding to the event start state and an initial value of the bit corresponding to the event end state are invalid values.

Further, the control unit is further configured to determine whether the last banknote processing process before the last power failure is complete according the recorded state of the event after power on, and continue to execute banknote processing before the last power failure when determining that the last banknote processing process before the last power failure is incomplete.

A method for recording a banknote processing state is provided according to another aspect of the present disclosure in order to achieve the foregoing purpose. A key step during a banknote processing process is defined as an event, and a state of the event is recorded in a nonvolatile memory during the banknote processing process.

Further, the state of the event includes event start state and event end state; the event start state indicates start of the event and the event end state indicates end of the event.

Further, the state of the event is recorded using a state word, and a value of the state word is modified when the state of the event changes.

Further, the state of the event includes event start state and event end state; the event start state indicates start of the event and the event end state indicates end of the event, wherein a bit corresponding to the event start state in the state word is set as a valid value when the event starts, and a bit corresponding to the event end state in the state word is set as a valid value when the event ends; an initial value of the bit corresponding to the event start state and an initial value of the bit corresponding to the event end state are invalid values.

A processing method of a banknote recognition apparatus is provided according to still another aspect of the present disclosure in order to achieve the foregoing purpose. The processing method of the banknote recognition apparatus includes that a banknote processing state is recorded using the method for recording a banknote processing state according to the present disclosure; whether the last banknote processing process before the last power failure is complete is determined according a recorded state of an event after power on; execution of banknote processing before the last power failure is continued when it is determined that the last banknote processing process before the last power failure is incomplete.

The present disclosure solves the problem that an abnormity often occurs when a banknote recognition apparatus stores banknote processing information to a nonvolatile memory upon a power failure, thus further implementing an effect of effectively storing the banknote processing information when the power failure occurs on the banknote recognition apparatus.

### BRIEF DESCRIPTION OF THE DRAWINGS

The accompanying drawings, which constitute a part of the present application, are used for providing further understanding to the present disclosure. The schematic embodiments of the present disclosure and the descriptions thereof are used for explaining the present disclosure and do not constitute an improper limitation to the present disclosure. In the accompanying drawings:

FIG. 1 is a schematic diagram of components of an electric module of a banknote recognition apparatus according to an embodiment of the present disclosure;

FIG. 2 is a schematic diagram of components of a structural module of a banknote recognition apparatus according to an embodiment of the present disclosure;

FIG. 3 is a flowchart of a method for recording a banknote processing state according to an embodiment of the present disclosure;

FIG. 4 is a flowchart of a banknote processing method according to an embodiment of the present disclosure; and

FIG. 5 is a flowchart of a power-on processing method of a banknote recognition apparatus according to an embodiment of the present disclosure.

### DETAILED DESCRIPTION OF THE EMBODIMENTS

It should be noted that the embodiments in the present application and the characteristics in the embodiments may be combined with each other if there is no conflict. The present disclosure will be expounded hereinafter with reference to the accompanying drawings and in combination with the embodiments.

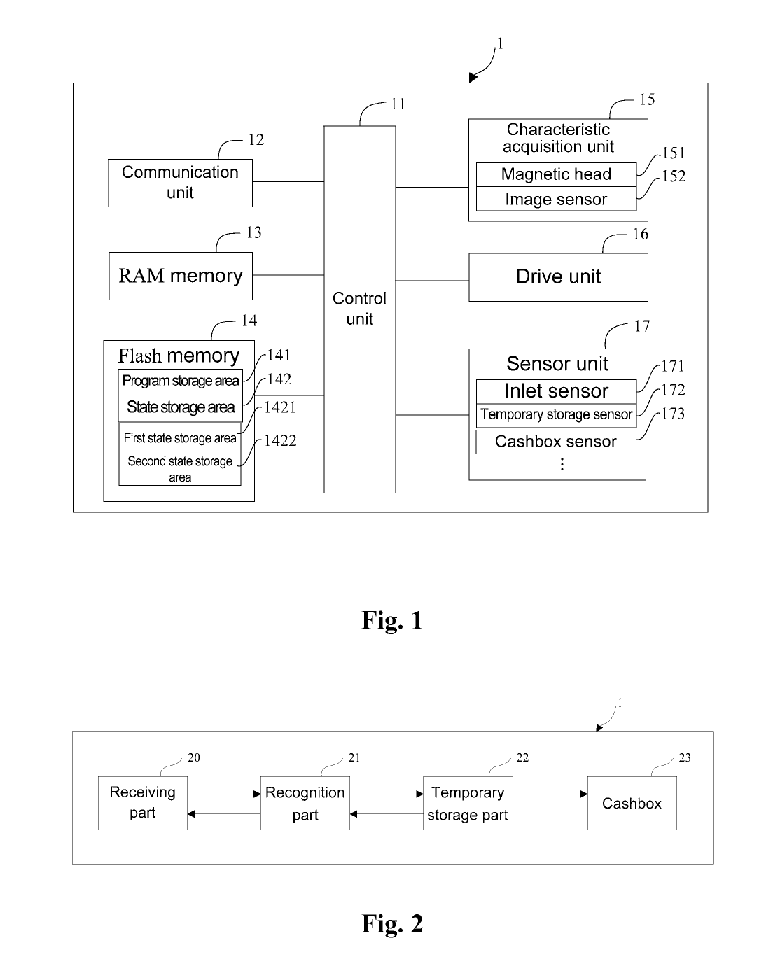

FIG. 1 is a schematic diagram of components of an electric module of a banknote recognition apparatus according to an embodiment of the present disclosure. As shown in FIG. 1, the banknote recognition apparatus 1 includes a control unit 11, a communication unit 12, a Random Access Memory (RAM) 13, a Flash memory 14, a characteristic acquisition unit 15, a drive unit 16 and a sensor unit 17.

The control unit 11 is configured to control other modules to work. For example, the control unit 11 controls the communication unit 12 to complete data transmission between the banknote recognition apparatus 1 and a host connected with the banknote recognition apparatus 1. The control unit 11 controls the Flash memory 14 to store a processing state of a banknote. The control unit 11 controls the drive unit 16 to drive the banknote to move in a conveying channel of the banknote recognition apparatus 1, and so on.

The communication unit 12 is configured to execute the data transmission between the banknote recognition apparatus 1 and the host connected with the banknote recognition apparatus 1. For example, the communication unit 12 receives a control command sent by the host, and the communication unit 12 uploads a recognition result of a to-be-recognized banknote in the recognition banknote recognition apparatus 1 to the host.

The RAM 13 is configured to store data and a variable generated during a running process of a control program of the banknote recognition apparatus 1. For example, the RAM 13 is configured to store image data of the to-be-recognized banknote and a recognition result of the to-be-recognized banknote, wherein the image data of to-be-recognized banknote and the recognition result of the to-be-recognized banknote are acquired by the characteristic acquisition unit 15, and is configured to store the latest state word representing a processing state of the banknote, and so on.

The Flash memory 14 includes a program storage area 141 and a state storage area 142, wherein the program storage area 141 is configured to store the control program of the banknote recognition apparatus 1. The state storage area 142 includes a first state storage area 1421 and a second state storage area 1422. The first state storage area 1421 and the second state storage area 1422 are used alternatively to store a plurality of state words generated at different moments during a banknote processing process.

The characteristic acquisition unit 15 is configured to acquire characteristic information of the to-be-recognized banknote, wherein the characteristic acquisition unit 15 includes a magnetic head 151 and an image sensor 152, wherein the magnetic head 151 is configured to read magnetic information distributed on the to-be-recognized banknote. The image sensor 152 may be a contact image sensor or a charge coupled device configured to acquire the image data of the to-be-recognized banknote. The characteristic acquisition unit 15 acquires the magnetic information and the image data of the to-be-recognized banknote to further acquire the characteristic information of the to-be-recognized banknote. For example, characteristic information, including a serial number, a safety line and a watermark and so on of the to-be-recognized banknote is acquired.

The drive unit 16 is configured to drive the to-be-recognized banknote to move in the conveying channel of the banknote recognition apparatus 1.

The sensor unit 17 is configured to detect a location of the to-be-recognized banknote, wherein the sensor unit 17 includes a plurality of sensors located at different locations of the banknote recognition apparatus 1. For example, the sensor unit 17 includes an inlet sensor 171, a temporary storage sensor 172, and a cashbox sensor 173, wherein the inlet sensor 171 is located at a banknote inlet of the banknote recognition apparatus 1, the temporary storage sensor 172 is located at a temporary storage location of the banknote recognition apparatus 1, the cashbox sensor 173 is located at an inlet of a cashbox of the banknote recognition apparatus 1, and so on. Each sensor is respectively configured to detect whether there is a banknote at the location where the sensor is located.

FIG. 2 is a schematic diagram of components of a structural module of a banknote recognition apparatus according to an embodiment of the present disclosure. As shown in FIG. 2, the banknote recognition apparatus 1 includes a receiving part 20, a recognition part 21, a temporary storage part 22 and a cashbox 23.

The receiving part 20 is arranged at a banknote inlet of the banknote recognition apparatus 1 and configured to store a banknote inputted by a user or returned by the banknote recognition apparatus 1.

The recognition part 21 is arranged on a conveying path from the receiving part 20 to the temporary storage part 22. The recognition part 21 is provided with a characteristic acquisition unit 15 (not shown in FIG. 2). When to-be-recognized banknotes arrive at the recognition part 21, the characteristic acquisition unit 15 acquires characteristic information of the to-be-recognized banknotes. A control unit 11 determines the authenticity, denomination and orientation of the banknotes according to the acquired characteristic information, and determines conditions including folding and damage, and pollution and so on, and divides, according to the authenticity, and the conditions including folding and damage, and pollution and so on of the to-be-recognized banknotes, the to-be-recognized banknotes into fit banknotes and unfit banknotes, wherein the fit banknotes refer to banknotes recognized as genuine banknotes without folding or damage or pollution, or those recognized as genuine banknotes that are folded or damaged or polluted slight, and does not affect reuse. The unfit banknotes refer to banknotes recognized as counterfeit banknotes or banknotes that are folded or damaged, or polluted, too serious to affect reuse. The banknotes determined by the recognition part 21 to be fit banknotes are conveyed to the temporary storage part 22, and the banknotes determined to be unfit banknotes are conveyed to the receiving part 20 and returned to the user.

The temporary storage part 22 temporarily stores the banknotes determined by the recognition part 21 to be fit banknotes. The banknote recognition apparatus 1 waits to receive operation information inputted by the user when the fit banknotes arrive at the temporary storage part 22. After receiving an operation acknowledgement command inputted by the user, the fit banknotes, which are stored in the temporary storage part 22 temporarily, are conveyed to the cashbox 23. After an operation cancelling command inputted by the user is received, the banknotes stored in the temporary storage part 22 temporarily are conveyed to the receiving part 20 and returned to the user.

The cashbox 23 is configured to store the fit banknotes, wherein the fit banknotes are conveyed from the temporary storage part 22 after the operation acknowledgement command inputted by the user is received.

When the banknote recognition apparatus processes banknotes, several key steps in the process of processing the banknotes are defined as key events (hereinafter referred to as events for short). An event start state and an event end state are set for each event, wherein the event start state indicates whether the event starts, and the event end state indicates whether the event ends. When an event has not started, both the event start state and the event end state of the event are “false”. When the event starts, the event start state thereof is “true”. When the event ends, the event end state thereof is “true”. During the process of processing the banknotes, all event states during the process of processing the banknotes are recorded using a state word, wherein the banknote recognition apparatus uses, according to the number of all event states, all bits or some bits of the state word to record the event states (a bit for recording an event state in the state word is called as a valid bit and a bit not used for recording an event state in the state word is called as an invalid bit hereinafter). Each valid bit corresponds to an event state. A certain valid bit of the state word is set as different values to represent that an event state corresponding to the bit is “true” or “false”. When a certain event state is “true”, a value of a bit corresponding to the event state is set as a valid state, e.g. “0”. On the contrary, a value of a bit corresponding to the event state is set as an invalid value, e.g. “1” when the event state is “false”.

The key steps may include one or more of the followings: a banknote is conveyed to the recognition part 21 from the receiving part 20; the banknote is recognized; the banknote is returned to the receiving part 20 from the recognition part 21; the banknote is conveyed to the temporary storage part 22 from the recognition part 21; the banknote is returned to the receiving part 20 from the temporary storage part 22; the banknote is conveyed to the cashbox 23 from the temporary storage part 22.

In a banknote recognition apparatus provided by an embodiment of the present disclosure, since a control unit 11 records a state of an event in a nonvolatile memory during a banknote processing process, the latest processing state may be stored accurately during the banknote processing process. It is unnecessary to store related banknote processing information again when an abnormal power failure of the banknote recognition apparatus occurs and it is unnecessary to add an extra power supply device, which can ensure that the banknote processing process being executed when the abnormal power failure occurs can be executed completely after power on again next time, thus avoiding an unnecessary dispute between a user and an institution owning the banknote recognition apparatus.

As mentioned above, a state of an event may be recorded using a state word. A first state storage area 1421 and a second state storage area 1422 of the nonvolatile memory 14 are configured to store state words recorded during the banknote processing process alternatively in order to store the state words effectively. A state storage area currently used in the first state storage area 1421 and the second state storage area 1422 is a valid state storage area. A storage unit currently used for storing a state word in the valid state storage area is a valid storage unit. The control unit 11 is configured to write, each time when a state word is stored, the state word into a valid storage unit, and update, each time after a state word is written, a valid storage unit into the next storage unit, set the other state storage area as a valid state storage area after the valid state storage area is full of state words, and execute an operation of erasing a state storage area full of state words.

An embodiment of the present disclosure further provides a method for recording a banknote processing state. In the method, a key step in a banknote processing process is defined as an event. In the banknote processing process, a state of the event is recorded in a nonvolatile memory. It should be noted that a method for recording a banknote processing state according to an embodiment of the present disclosure may be executed through a banknote recognition apparatus according to an embodiment of the present disclosure. A banknote recognition apparatus according to an embodiment of the present disclosure may be also configured to execute a method for recording a banknote processing state according to an embodiment of the present disclosure.

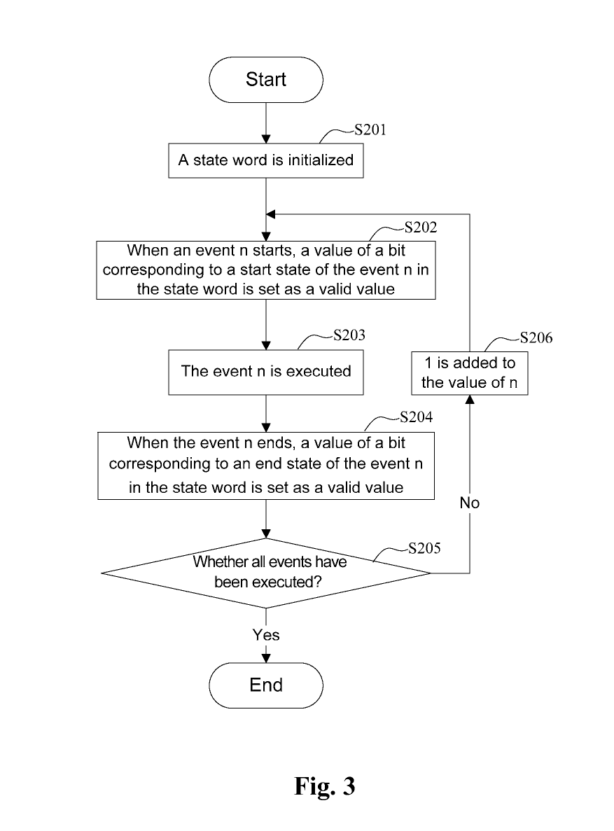

FIG. 3 is a flowchart of a method for recording a banknote processing state according to an embodiment of the present disclosure. The flow includes the following steps.

Step 201: A state word is initialized.

Before a banknote processing process starts, a control unit initializes a state word stored in an RAM. A value of each invalid bit of the state word is initialized as a default value. For example, the value of each invalid bit of the state word is initialized as “1”. A value of each valid bit of the state word is initialized as an invalid value, that is, the value of each valid bit is set as a value used when an event state corresponding to the bit is “false”. For example, the value of each valid bit of the state word is initialized as “1”.

Step 202: When an event n starts, a value of a bit corresponding to a start state of the event n in the state word is set as a valid value.

When the event n starts, the state word stored in the RAM is updated so that the bit corresponding to the start state of the event n in the state word is a valid value, that is, the start state of the event n is set as “true”. In the meanwhile, the updated state word is stored in a valid state storage area of a Flash memory, wherein n is a sequence number of an event defined during the banknote processing process. A value of n is the sequence number of a first event defined in the banknote processing process when the banknote processing process starts. For example, the value of n is 1.

It should be noted that the valid state storage area is a first state storage area or a second state storage area of the Flash memory, wherein the first state storage area and the second state storage area are used for alternatively storing a state word generated during the banknote processing process. A state storage area used currently is a valid state storage area. The control unit writes a flag into a storage unit of a certain state storage area so as to set the state storage area as a valid state storage area. In the meanwhile, the control unit writes, each time when a state word is stored, the state word into a valid storage unit of the valid state storage area, wherein the valid storage unit refers to a storage unit to which state word of a current time will be written in the valid state storage area. A valid storage unit of the valid state storage area used for the first time is a first storage unit of the state storage area. A valid storage unit is updated into the next storage unit each time after a state word is written. When a valid storage unit is the last storage unit of the valid state storage area, the control unit sets, after writing a state word into the last storage unit, the other state storage area as a valid state storage area by writing a flag into a specific storage unit of the other state storage unit, and erases the state storage area full of state words after writing the state word into the new valid state storage area for the first time.

Step 203: The event n is executed.

The control unit controls to execute the event n. For example, an event of acquiring characteristic information of a to-be-recognized banknote is executed.

Step 204: When the event n ends, a value of a bit corresponding to an end state of the event n in the state word is set as a valid value.

When the event n ends, the state word stored in the RAM is updated so that the value of the bit corresponding to the end state of the event n in the state word is a valid value, that is, the end state of the event n is set as “true”. In the meanwhile, the updated state word is stored in a valid state storage area of the Flash memory.

Step 205: Whether all events have been executed is determined.

The control unit determines, according to the event executed in Step 203, whether all events defined in the banknote processing process have been executed. If yes, the process is terminated. Otherwise, Step 206 is executed. When the event executed in Step 203 is the last event defined in the banknote processing process, all events defined in the banknote processing process have been executed when the event ends, that is, the banknote processing process has ended. Otherwise, it is indicated that the banknote processing process has not ended, and it is necessary continue executing the next event defined in the banknote processing process.

Step 206: 1 is added to the value of n.

The control unit adds 1 to the value of n and continues to perform Step 202, that is, the next event defined in the banknote processing process is executed.

Through the control method according to the present embodiment, when any event state in all event states changes during the banknote processing process, the control unit modifies a value of a state word of banknote processing, and stores a value of the modified state word in the nonvolatile memory. Whether each event in the banknote processing process starts or ends is indicated by an event start state and an event end state of the event. Therefore, the latest state of the banknote processing process may be stored in the nonvolatile memory accurately during the banknote processing process via the control method of the present embodiment. It is unnecessary to store related banknote processing information again when a banknote recognition apparatus is powered off abnormally.

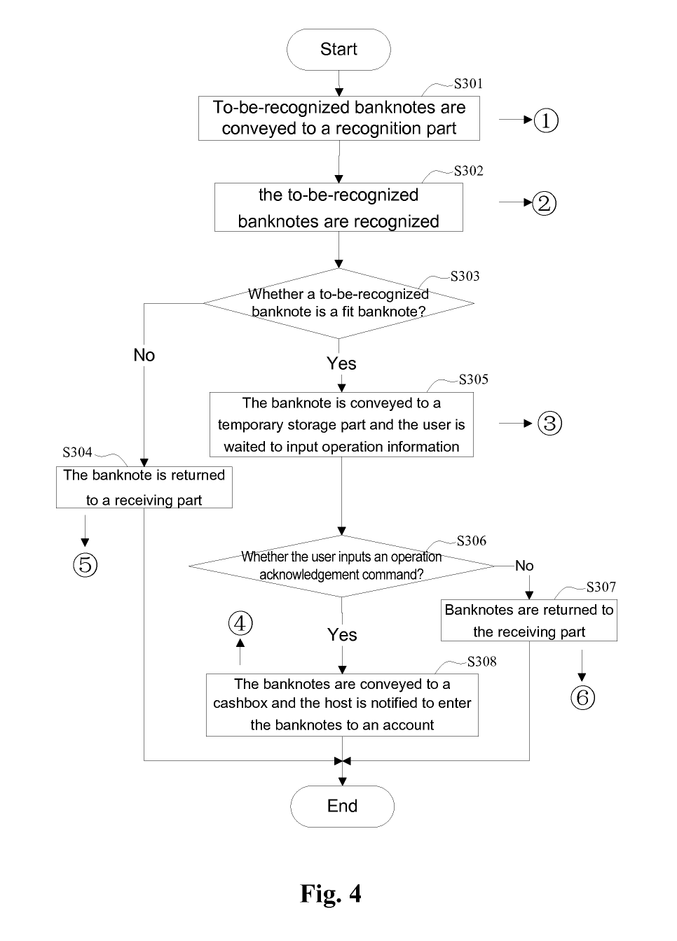

FIG. 4 is a flowchart of a banknote processing method according to an embodiment of the present disclosure. The banknote processing flow is executed when a banknote recognition apparatus detects that to-be-recognized banknotes are placed at a banknote inlet. The flow includes the following steps.

Step 301: To-be-recognized banknotes are conveyed to a recognition part.

When it is detected that to-be-recognized banknotes are placed at a banknote inlet of a banknote recognition apparatus, a control unit controls a drive unit to drive the to-be-recognized banknotes to move in a conveying channel to convey the to-be-recognized banknotes from a receiving part to a recognition part.

Step 302: The to-be-recognized banknotes are recognized.

When the to-be-recognized banknotes arrive at the recognition part, the control unit controls a characteristic acquisition unit to acquire characteristic information of the to-be-recognized banknotes. For example, the control unit acquires the characteristic information of the to-be-recognized banknotes by controlling a magnetic head of the characteristic acquisition unit to read magnetic information distributed on the to-be-recognized banknotes and controlling an image sensor to acquire image data of the to-be-recognized banknotes. For example, characteristic information, including a serial number, a safety line and a watermark and so on of the to-be-recognized banknotes is acquired. In the meanwhile, the control unit recognizes the to-be-recognized banknotes according to the acquired characteristic information of the to-be-recognized banknotes, thus further determining the authenticity, denomination and orientation of the to-be-recognized banknotes, and determining conditions, including folding and damage, and pollution and so on of the to-be-recognized banknotes, and divides, according to the authenticity, and the conditions including folding and damage, and pollution and so on of to-be-recognized banknotes, the to-be-recognized banknotes into fit banknotes and unfit banknotes. The control unit uploads a recognition result of a to-be-recognized banknote, i.e. whether the to-be-recognized banknote is a fit banknote or a unfit banknote, and a denomination of the to-be-recognized banknote and so on, to a host through a communication unit so that the host can display to a user related information of the to-be-recognized banknote.

Step 303: Whether a to-be-recognized banknote is a fit banknote is determined.

The control unit determines, according to the recognition result of the to-be-recognized banknote recognized in Step 302, whether the to-be-recognized banknote is a fit banknote. If yes, Step 305 is performed. Otherwise, Step 304 is performed when the to-be-recognized banknote is a unfit banknote.

Step 304: The banknote is returned to the receiving part.

When the to-be-recognized banknote is recognized as a unfit banknote, the control unit controls the drive unit to drive the banknote to move from the recognition part to the receiving part to return the unfit banknote to the receiving part.

Step 305: The banknote is conveyed to a temporary storage part and the user is waited to input operation information.

When the to-be-recognized banknote is recognized as a fit banknote, the control unit controls the drive unit to drive the banknote to move from the recognition part to the temporary storage part. In the meanwhile, the banknote recognition apparatus waits for the user to input operation information through the host.

Step 306: Whether the user inputs an operation acknowledgement command is determined.

After receiving the operation information inputted by the user through the host, the control unit determines whether the operation information inputted by the user is an operation acknowledgement command. If yes, Step 308 is performed. Otherwise, Step 307 is performed.

Step 307: Banknotes are returned to the receiving part.

When the operation information inputted by the user is not the operation acknowledgement command, that is, the operation information inputted by the user is an operation cancelling command, the control unit controls the drive unit to drive the banknotes to move from the temporary storage part to the receiving part so as to return the banknotes stored by the temporary storage part temporarily to the receiving part.

Step 308: The banknotes are conveyed to a cashbox and the host is notified to charge to an account.

When the operation information inputted by the user is the operation acknowledgement command, the control unit controls the drive unit to drive the banknotes from the temporary storage part to the cashbox to store fit banknotes in the cashbox. In the meanwhile, when it is detected that the banknotes have arrived at an inlet of the cashbox, the control unit controls a communication unit to upload information indicating that the banknotes have been stored in the cashbox so that the host performs an operation of charging to an account.

As shown in FIG. 4, the banknote processing method includes 6 key steps illustrated by to. The control unit defines these 6 key steps as 6 events in total, i.e. Event to Event. During the banknote processing process, 12 event states are used for indicating banknote processing states. These 12 event states are Event start, Event end, Event start, Event end . . . Event start, Event end, respectively. In the meanwhile, a 16-bit state word is used for recording these 12 event states during the banknote processing process, wherein the four bits from high to low in all bits of the state word are invalid bits, and a default value of each invalid bit is set as “1”. The twelve bits from low to high in all bits of the state word are valid bits and each valid bit corresponds to an event state, wherein from low to high, the first bit in the state word corresponds to a start state of Event, the second bit corresponds to an end state of Event . . . and so on, and the twelfth bit corresponds to an end state of Event. All events are in a non-start state before the banknote processing starts. A value of a bit corresponding to each event state is “1”. When execution of a certain event starts, a value of a bit corresponding to an event start state of the event is set as “0”. When execution of a certain event ends, a value of a bit corresponding to an event end state of the event is set as “0”. When any event state changes, the control unit modifies a value of the state word of banknote processing, and stores the modified state word in a valid state storage area of a Flash memory. Therefore, the banknote recognition apparatus further executes an operation of storing a state word to a valid state storage area of the Flash memory twice besides the operation as shown in FIG. 4 during an execution process of each key step as shown in FIG. 4.

It may be learned from FIG. 4 that events occurs in three orders according to a recognition result of a to-be-recognized banknote and operation information inputted by the user during the banknote processing process. When the to-be-recognized banknote is recognized as a fit banknote and the operation information inputted by the user is an operation acknowledgement command, events occur in an order of \textcircled{1}→\textcircled{2}→\textcircled{3}→\textcircled{4}. When the to-be-recognized banknote is recognized as a unfit banknote, events occur in an order of \textcircled{1}→\textcircled{2}→\textcircled{5}. When the to-be-recognized banknote is recognized as a fit banknote and the operation information inputted by the user is an operation cancelling command, events occur in an order of \textcircled{1}→\textcircled{2}→\textcircled{3}→\textcircled{6}.

Table 1 shows a process in which a state word changes accordingly as each event state changes when a to-be-recognized banknote is recognized as a fit banknote and operation information inputted by the user is an operation acknowledgement command. When the control unit detects that a banknote is inputted into a banknote inlet, the control unit sets values of bits corresponding to all event states in the state word as “1” before processing the banknote. A value of the state word is 0xFFFF at the moment. When execution of Event starts, that is, when the control unit starts to control the drive unit to convey the to-be-recognized banknote to the recognition part, the control unit sets a value of a bit corresponding to a start state of Event in the state word as “0”. The value of the state word is 0xFFFE at the moment. The control unit stores the state word in the valid state storage area. When execution of Event ends, that is, when the to-be-recognized banknote has already arrived at the recognition part, the control unit sets a value of a bit corresponding to an end state of Event in the state word as “0”. The value of the state word is 0xFFFC at the moment. The control unit stores the state word in the valid state storage area, and so forth. When execution of Event ends, that is, the banknote is sent to the cashbox and the host has been notified to charge to an account, the control unit sets a value of a bit corresponding to an end state of Event as “0”. The value of the state word is 0xFF00 at the moment.

TABLE 1

| Event | | | | | | | | | | |
|---|---|---|---|---|---|---|---|---|---|---|
| execution | Invalid | Invalid | Invalid | Invalid | Event\textcircled{6} | Event\textcircled{6} | Event\textcircled{5} | Event\textcircled{5} | Event\textcircled{4} | Event\textcircled{4} |
| number | bit | bit | bit | bit | end | start | end | start | end | start |
| Null | 1 | 1 | 1 | 1 | 1 | 1 | 1 | 1 | 1 | 1 |
| \textcircled{1} | 1 | 1 | 1 | 1 | 1 | 1 | 1 | 1 | 1 | 1 |
| \textcircled{1} | 1 | 1 | 1 | 1 | 1 | 1 | 1 | 1 | 1 | 1 |
| \textcircled{2} | 1 | 1 | 1 | 1 | 1 | 1 | 1 | 1 | 1 | 1 |
| \textcircled{2} | 1 | 1 | 1 | 1 | 1 | 1 | 1 | 1 | 1 | 1 |
| \textcircled{3} | 1 | 1 | 1 | 1 | 1 | 1 | 1 | 1 | 1 | 1 |
| \textcircled{3} | 1 | 1 | 1 | 1 | 1 | 1 | 1 | 1 | 1 | 1 |
| \textcircled{4} | 1 | 1 | 1 | 1 | 1 | 1 | 1 | 1 | 1 | 0 |
| \textcircled{4} | 1 | 1 | 1 | 1 | 1 | 1 | 1 | 1 | 0 | 0 |

| Event | | | | | | | |
|---|---|---|---|---|---|---|---|
| execution | Event\textcircled{3} | Event\textcircled{3} | Event\textcircled{2} | Event\textcircled{2} | Event\textcircled{1} | Event\textcircled{1} | State |
| number | end | start | end | start | end | start | word |
| Null | 1 | 1 | 1 | 1 | 1 | 1 | 0xFFFF |
| \textcircled{1} | 1 | 1 | 1 | 1 | 1 | 0 | 0xFFFE |
| \textcircled{1} | 1 | 1 | 1 | 1 | 0 | 0 | 0xFFFC |
| \textcircled{2} | 1 | 1 | 1 | 0 | 0 | 0 | 0xFF F8 |
| \textcircled{2} | 1 | 1 | 0 | 0 | 0 | 0 | 0xFFF0 |
| \textcircled{3} | 1 | 0 | 0 | 0 | 0 | 0 | 0xFFE0 |
| \textcircled{3} | 0 | 0 | 0 | 0 | 0 | 0 | 0xFFC0 |
| \textcircled{4} | 0 | 0 | 0 | 0 | 0 | 0 | 0xFF 80 |
| \textcircled{4} | 0 | 0 | 0 | 0 | 0 | 0 | 0xFF 00 |

FIG. 2 shows a process in which a state word changes accordingly as each event state changes when a to-be-recognized banknote is recognized as a unfit banknote. When the to-be-recognized banknote is recognized as a unfit banknote, a value of the state word is 0xFCF0 after banknote processing ends, that is, after execution of Event ends, since Event, Event and Event will not be executed.

TABLE 2

| Event | | | | | | | | | | |
|---|---|---|---|---|---|---|---|---|---|---|
| execution | Invalid | Invalid | Invalid | Invalid | Event\textcircled{6} | Event\textcircled{6} | Event\textcircled{5} | Event\textcircled{5} | Event\textcircled{4} | Event\textcircled{4} |
| number | bit | bit | bit | bit | end | start | end | start | end | start |
| Null | 1 | 1 | 1 | 1 | 1 | 1 | 1 | 1 | 1 | 1 |
| \textcircled{1} | 1 | 1 | 1 | 1 | 1 | 1 | 1 | 1 | 1 | 1 |
| \textcircled{1} | 1 | 1 | 1 | 1 | 1 | 1 | 1 | 1 | 1 | 1 |
| \textcircled{2} | 1 | 1 | 1 | 1 | 1 | 1 | 1 | 1 | 1 | 1 |
| \textcircled{2} | 1 | 1 | 1 | 1 | 1 | 1 | 1 | 1 | 1 | 1 |
| \textcircled{5} | 1 | 1 | 1 | 1 | 1 | 1 | 1 | 0 | 1 | 1 |
| \textcircled{5} | 1 | 1 | 1 | 1 | 1 | 1 | 0 | 0 | 1 | 1 |

| Event | | | | | | | |
|---|---|---|---|---|---|---|---|
| execution | Event\textcircled{3} | Event\textcircled{3} | Event\textcircled{2} | Event\textcircled{2} | Event\textcircled{1} | Event\textcircled{1} | State |
| number | end | start | end | start | end | start | word |
| Null | 1 | 1 | 1 | 1 | 1 | 1 | 0xFFFF |
| \textcircled{1} | 1 | 1 | 1 | 1 | 1 | 0 | 0xFFFE |
| \textcircled{1} | 1 | 1 | 1 | 1 | O | 0 | 0xFFFC |
| \textcircled{2} | 1 | 1 | 1 | 0 | 0 | 0 | 0xFFF8 |
| \textcircled{2} | 1 | 1 | 0 | 0 | 0 | 0 | 0xFFF0 |
| \textcircled{5} | 1 | 1 | 0 | 0 | 0 | 0 | 0xFEF0 |
| \textcircled{5} | 1 | 1 | 0 | 0 | 0 | 0 | 0xFCF0 |

FIG. 3 shows a process in which a state word changes accordingly as each event state changes when a to-be-recognized banknote is recognized as a fit banknote and operation information inputted by the user is an operation cancelling command. When the to-be-recognized banknote is recognized as a fit banknote, but the operation information inputted by the user is an operation cancelling command, a value of the state word is 0xF3C0 after banknote processing ends, that is, after execution of Event ends, since Event and Event will not be executed.

TABLE 3

| Event | | | | | | | | | | |
|---|---|---|---|---|---|---|---|---|---|---|
| execution | Invalid | Invalid | Invalid | Invalid | Event\textcircled{6} | Event\textcircled{6} | Event\textcircled{5} | Event\textcircled{5} | Event\textcircled{4} | Event\textcircled{4} |
| number | bit | bit | bit | bit | end | start | end | start | end | start |
| Null | 1 | 1 | 1 | 1 | 1 | 1 | 1 | 1 | 1 | 1 |
| \textcircled{1} | 1 | 1 | 1 | 1 | 1 | 1 | 1 | 1 | 1 | 1 |
| \textcircled{1} | 1 | 1 | 1 | 1 | 1 | 1 | 1 | 1 | 1 | 1 |
| \textcircled{2} | 1 | 1 | 1 | 1 | 1 | 1 | 1 | 1 | 1 | 1 |
| \textcircled{2} | 1 | 1 | 1 | 1 | 1 | 1 | 1 | 1 | 1 | 1 |
| \textcircled{3} | 1 | 1 | 1 | 1 | 1 | 1 | 1 | 1 | 1 | 1 |
| \textcircled{3} | 1 | 1 | 1 | 1 | 1 | 1 | 1 | 1 | 1 | 1 |
| \textcircled{6} | 1 | 1 | 1 | 1 | 1 | 0 | 1 | 1 | 1 | 1 |
| \textcircled{6} | 1 | 1 | 1 | 1 | 0 | 0 | 1 | 1 | 1 | 1 |

| Event | | | | | | | |
|---|---|---|---|---|---|---|---|
| execution | Event\textcircled{3} | Event\textcircled{3} | Event\textcircled{2} | Event\textcircled{2} | Event\textcircled{1} | Event\textcircled{1} | State |
| number | end | start | end | start | end | start | w0rd |
| Null | 1 | 1 | 1 | 1 | 1 | 1 | 0xFFFF |
| \textcircled{1} | 1 | 1 | 1 | 1 | 1 | 0 | 0xFFFE |
| \textcircled{1} | 1 | 1 | 1 | 1 | 0 | 0 | 0xFFFC |
| \textcircled{2} | 1 | 1 | 1 | 0 | 0 | 0 | 0xFF F8 |
| \textcircled{2} | 1 | 1 | 0 | 0 | 0 | 0 | 0xFFF0 |
| \textcircled{3} | 1 | 0 | 0 | 0 | 0 | 0 | 0xFFE0 |
| \textcircled{3} | 0 | 0 | 0 | 0 | 0 | 0 | 0xFFC0 |
| \textcircled{6} | 0 | 0 | 0 | 0 | 0 | 0 | 0xFB C0 |
| \textcircled{6} | 0 | 0 | 0 | 0 | 0 | 0 | 0xF3 C0 |

In an embodiment of the present disclosure, when a state of an event is “true”, a value of a bit corresponding to the state of the event in a state word is “0” or “1”, and a default value of an invalid bit in the state word is determined by a property of a Flash memory. For example, if a default value of each storage unit of the Flash memory is 0xFFFF after an erasing operation, then when a control unit sets a state of a certain event as “true”, a value of a bit corresponding to the state of the event in the state word is set as “0”. In the meanwhile, a default value of an invalid bit in the state word is set as “1”, that is, a default value of the state word is set as 0xFFFF when all events have not started. A value of each valid bit of the state word changes accordingly with a start state and an end state of each event after a banknote processing process starts. After execution of a certain event starts, a value of a bit corresponding to an event start state of the event in the state word is set as “0”. After execution of a certain event ends, a value of a bit corresponding to an event end state of the event is set as “0”. Since at least one event has already started when the state word is stored to the Flash memory, a value of at least one bit of the stored state word is “0”, that is, the stored state word is a non-0xFFFF value, so as to enable the control unit to distinguish a storage unit in which the state word is stored from a storage unit in which the state word is not stored.

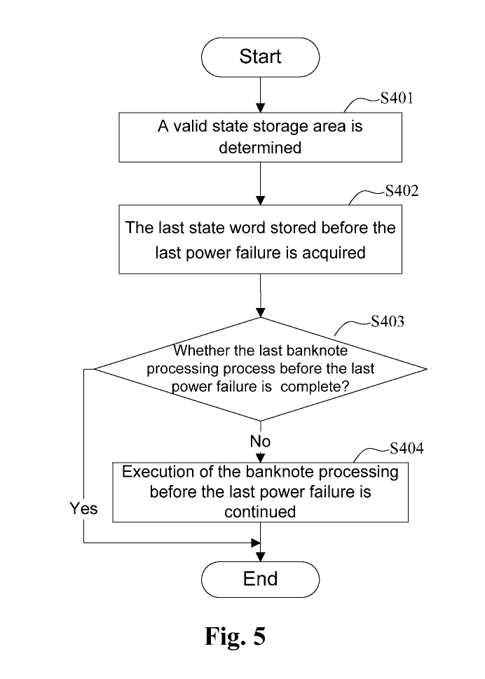

FIG. 5 is a flowchart of a power-on processing method of a banknote recognition apparatus according to an embodiment of the present disclosure. The banknote recognition apparatus executes the flow each time after being powered on. The process includes the following steps.

Step 401: A valid state storage area is determined.

A control unit reads data stored in a specific storage unit of a first state storage area and reads data stored in a specific storage unit of a second state storage area, wherein the specific storage unit is a storage unit configured to store a flag. The control unit determines whether the read data is a flag. If yes, the state storage area from which the data is read is determined to be a valid state storage area. It should be noted that the flag is data different from all possible state words, e.g. the flag is 0xAAAA or 0x5555.

Step 402: The last state word stored before the last power failure is acquired.

A storage unit in which a state word is written for the last time in the valid state storage area is searched to acquire the last state word stored before the last power failure. For example, the control unit reads, from a first storage unit of the valid state storage area, data stored in each storage unit in turn. When it is enquired that data stored in a certain storage unit is 0xFFFF, it is determined that data stored in the last storage unit of the storage unit is the last state word stored before the last power failure. Since all stored state words are non-0xFFFF values, the control unit can find the last state word before the last power failure accurately.

Step 403: Whether the last banknote processing process before the last power failure is complete is determined.

The last state word stored before the last power failure is analyzed to determine whether the last banknote processing process before the last power failure is complete. For example, in the banknote processing method as shown in FIG. 4, if the banknote processing process is complete, the state word stored for the last time should be 0xFF00 or 0xFCF0 or 0xF3C0. When a state word is not any of the three values, it is indicated that the last banknote processing process is incomplete, that is, an abnormal power failure occurs during the last banknote processing process. When it is detected that the last banknote processing process before the last power failure is complete, the flow is terminated. Otherwise, Step 404 is performed.

Step 404: Execution of the banknote processing before the last power failure is continued.

When it is detected that the last banknote processing process before the last power failure is incomplete, a banknote processing event being executed during the last power failure is determined according to the state word, and execution of the banknote processing is continued from the event. For example, when the last state word stored before the last power failure is 0xFFF8, it is indicated that execution of Event has started, but has not ended. Therefore, the banknote recognition apparatus continues to execute banknote processing from Event, that is, characteristic of a to-be-recognized banknote is acquired again to further recognize the to-be-recognized banknote.

Through the control method of the present embodiment, whether the last banknote processing process before the last power failure is complete is determined through reading the last state word stored in a nonvolatile memory when the banknote recognition apparatus is powered on. When the banknote processing process is incomplete, a banknote processing event being executed during the last power failure is determined, and execution of banknote processing is continued from the event. Therefore, the control method of the present embodiment ensures that the banknote processing process being executed during the last power failure can be executed completely.

In a banknote recognition apparatus and a banknote processing method according to the embodiments of the present disclosure, the latest processing state can be stored in a nonvolatile memory accurately during a banknote processing process, thus it is unnecessary to store related banknote processing information again when an abnormal power failure of banknote recognition apparatus occurs. Compared with the prior art, the banknote recognition apparatus of the present disclosure can ensure that banknote processing being executed during the abnormal power failure can be executed completely without adding an extra power supply device after power is turned on next time, thus avoiding an unnecessary dispute between a user and an institution owning the banknote recognition apparatus.

Obviously, those skilled in the art should understand that, each module or each step of the present disclosure may be implemented by a universal computing device. They may be concentrated on a single computing device or distributed on a network composed of a plurality of computing devices. Optionally, they may be implemented by program codes executable by a computing device so that they may be stored in a storage device and executed by the computing device, or they may be implemented by respectively fabricating them into each integrated circuit module, or by fabricating a plurality of modules or steps of them into a single integrated circuit module. In this way, the present disclosure is not limited to any specific combination of software and hardware.

The above are only preferred embodiments of the present invention, and are not used for limiting the present invention. For those skilled in the art, the present invention may have various alterations and variations. Any modification, equivalent replacement, improvement and so on made within the spirit and principle of the present invention should be included within the scope of protection of the present invention.

1. A banknote recognition apparatus, comprising:
a nonvolatile memory; and
a control unit configured to record a state of an event to the nonvolatile memory during a banknote processing process,
wherein the event is a key step in the banknote processing process.

2. The banknote recognition apparatus according to claim 1, wherein the state of the event includes event start state and event end state; the event start state indicates start of the event and the event end state indicates end of the event.

3. The banknote recognition apparatus according to claim 1, wherein
the nonvolatile memory is configured to record the state of the event using a state word;
the control unit is configured to modify a value of the state word when the state of the event changes.

4. The banknote recognition apparatus according to claim 3, wherein the state of the event includes event start state and event end state; the event start state indicates start of the event and the event end state indicates end of the event, wherein the control unit is configured to set a bit corresponding to the event start state in the state word as a valid value when the event starts, and set a bit corresponding to the event end state in the state word as a valid value when the event ends; an initial value of the bit corresponding to the event start state and an initial value of the bit corresponding to the event end state are invalid values.

5. The banknote recognition apparatus according to claim 1, wherein the control unit is further configured to determine whether the last banknote processing process before last power failure is complete according recorded state of the event after power on, and continue to execute banknote processing before the last power failure when determining that the last banknote processing process before the last power failure is incomplete.

6. A method for recording a banknote processing state, wherein a key step during a banknote processing process is defined as an event, and a state of the event is recorded in a nonvolatile memory during the banknote processing process.

7. The method according to claim 6, wherein the state of the event includes event start state and event end state; the event start state indicates start of the event and the event end state indicates end of the event.

8. The method according to claim 6, wherein the state of the event is recorded using a state word, and a value of the state word is modified when the state of the event changes.

9. The method according to claim 8, wherein the state of the event includes event start state and event end state; the event start state indicates start of the event and the event end state indicates end of the event, wherein a bit corresponding to the event start state in the state word is set as a valid value when the event starts, and a bit corresponding to the event end state in the state word is set as a valid value when the event ends; an initial value of the bit corresponding to the event start state and an initial value of the bit corresponding to the event end state are invalid values.

10. A method of processing a banknote recognition apparatus comprising:
recording a banknote processing state, wherein recording the banknote processing state comprises defining a key step as an event and recording a state of the event in a nonvolatile memory;
determining whether a last banknote processing process before a last power failure is complete according a recorded state of an event after power on; and
continuing to execute the last banknote processing process when it is determined that the last banknote processing process before the last power failure is incomplete.
